(19) United States
(12) Patent Application Publication
(10) Pub. No.: US 2012/0286561 A1
(43) Pub. Date: Nov. 15, 2012

(54) WHEELBARROW RIM

(75) Inventor: Moises Sheinberg Frenkel, Distrito Federal (MX)

(73) Assignee: TRUPER HERRAMIENTAS, SA DE CV, Estado de Mexico (MX)

(21) Appl. No.: 13/436,509

(22) Filed: Mar. 30, 2012

(30) Foreign Application Priority Data
May 13, 2011 (MX) MX/U/2011/000207

(51) Int. Cl. B60B 1/02

(52) U.S. Cl. 301/58

(57) ABSTRACT

The present invention consists in an improved wheelbarrow rim comprised of a series of radial central ribs on the front side of said portions, and a series of sections forming the rim. By virtue of calculating the moment of inertia of the rim, it can withstand greater loads when being manufactured of a metal sheet of 1.06 mm thickness, resulting in savings in production material, and at the same time a greater load capacity. Additionally, the central radial ribs impart a sense of movement.

### TECHNICAL FIELD OF THE INVENTION

The present invention relates to, in general, an improved rim for wheelbarrow applications. In particular this invention refers to an improvement in rims for wheelbarrow, the rims having central radial ribs to withstand heavier loads. Even more specifically, it relates to rims fitted with five central ribs, and being of a geometric shape different from the currently existing rims.

### BACKGROUND OF THE INVENTION

In the state of the art there have been several manufacturing problems regarding wheelbarrow rims. The wheelbarrow rims that have prevailed in the market have completely flat sides and/or flat sections as shown in FIG. 1. FIG. 1 shows a cross-section of a rim of the state of the art (which consists of two sections joined to support a tire). Specifically, the shortcoming of this type of rims is a low load capacity due to their flat sides and/or sections. Furthermore, the rims shown in FIG. 1 are mainly made of metal sheets gauge 18 (1.21 mm), which is a disadvantage since it requires greater amounts of manufacturing material, and causes the rim to be heavier. In general, the state of the art rims have flat sides, curved or otherwise, which represent disadvantages, that will be made evident by the present specification.

On the other hand, there have been unsuccessful attempts to create rims without flat sides, specifically U.S. Pat. No. 2,603,267 which shows a rim featuring, a series of pieces having a series of holes as shown in FIG. 2 of said document. This particular rim is handicapped by a lower moment of inertia (the measurement of the rotational inertia of a body), as calculated by the parallel axis theorem, which results in a reduced loading capacity and the need of sheets of higher gauge for manufacturing, which in turn makes it heavier.

Furthermore the state of the art does not demonstrates the existence of a rim made of a metal sheet-gauge 19 (1.02 mm) that can pass the performance tests required by standards, and the resistance and distortion criteria; in addition, there is no evidence in the state of the art of the existence of central ribs or changes in the shaping radiuses form.

Therefore, no rim with central ribs and changes in the shaping radiuses form exist in the state of the art.

### OBJECT OF THE INVENTION

The main object of the present invention is the production of a wheelbarrow rim having central ribs.

A second object of the present invention is the production of a wheelbarrow rim having innovative shaping radiuses.

A third object of the present invention, is the production of a wheelbarrow rim having five central ribs.

A fourth object of the present invention is the production of a wheelbarrow rim geometrically configured to fit the wheelbarrow tires that currently exist in the market.

A fifth object of the present invention is the production of a wheelbarrow rim manufactured from a thin sheet, as opposed to the rims of the state of the art.

A sixth object of the present invention is the production of a wheelbarrow rim having a greater moment of inertia, compared with the rims of the state of the art.

A seventh object of the present invention is the production of a wheelbarrow rim that, by means of a greater moment of inertia, has a greater loading capacity.

An eight object of the present invention is the production of a wheelbarrow rim that is formed by a three-step die, and the forming process is by drawing, central pivot-punching, and final cutting.

A ninth object of the present invention is the production of a wheelbarrow rim which optimizes the raw materials used in its manufacturing without negatively impacting the quality and performance of the product.

Lastly, other object of the present invention is the production of a wheelcart rim that imparts a sense of movement thanks to the central ribs.

Additional advantages shall be evident form, the attached claims.

### BRIEF DESCRIPTION OF THE DRAWINGS

In order to provide a better understanding of the invention, the following drawings are attached:

FIG. 1 is a view of a portion of a rim gauge 18 of the state of the art.

FIG. 2 is a cross-section view of the first portion of the wheelbarrow rim in accordance with the main embodiment of the present invention.

FIG. 3 refers to a front view of the wheelbarrow of the present invention.

FIG. 4 is a lateral view of the two portions of the wheelbarrow rim.

FIG. 5 refers to a perspective view of the wheelbarrow of the present invention.

FIG. 6 refers to a front view of a wheelbarrow rim which can be made by the with the teachings of the present invention.

### DETAILED DESCRIPTION OF THE INVENTION

It is understood that the present invention is not limited to a wheelbarrow rim as described. The knowledge of the present invention may be applied to the manufacturing of other types of rims, wherein the ribs may provide a technical advantage as described herein.

In the present invention there are references to inertia (I symbol), which is a measurement of the rotational inertia of a body, specifically, the wheelbarrow rim. When a body turns around one of the main inertia axis (the rim turns by means of bearings), the rotational inertia may be represented as a scalar magnitude known as moment of inertia. However, in the present case the rotational inertia has to be represented through a set of inertia moments and components that constitute the inertia tensor. The moment of inertia reflects the mass distribution of a rim or a rotating particle system, in relation to a turning axis (bearings). The moment of inertia only depends on the geometry of the body, and the position of the turning axis, it does not depend on the forces that intervene in the movement. The roles of the moment of inertia and the inertial mass are analogous in regards to the rectilinear and uniform movements.

For calculating the moment of inertia, we use the Parallel Axis Theorem (Steiner's Theorem, named after Jakob Steiner) where the moment of inertia of an area, arc or volume in relation to any axis is equal to the moment of inertia in relation to a parallel axis that passes through the centroid plus the product of the area, arc length or volume multiplied by the squared distance between the two parallel axis. Specifically, the present rim consists of an area and a series of arcs, thus the moment of inertia was calculated as follows:

1. Dividing the compounded area in various single parts.

2. Determining the areas of the parts.

3. Determining the coordinates of the center of mass of such parts in relation to the axis X and Y. Then calculating the center of mass of the entire shape formed by all the above partial areas.

4. Calculating the distances of the center of mass of each area in relation to the total center of mass of the shape.

5. Calculating the moments of inertia of the parts in relation to their center of mass axis (which will be parallel to X and Y).

6. Calculating the moment of inertia of each part in relation to the axis X and Y, by applying Steiner's Theorem of parallel axis.

7. Calculating the moments of inertia of the compounded area from the above moments of inertia.

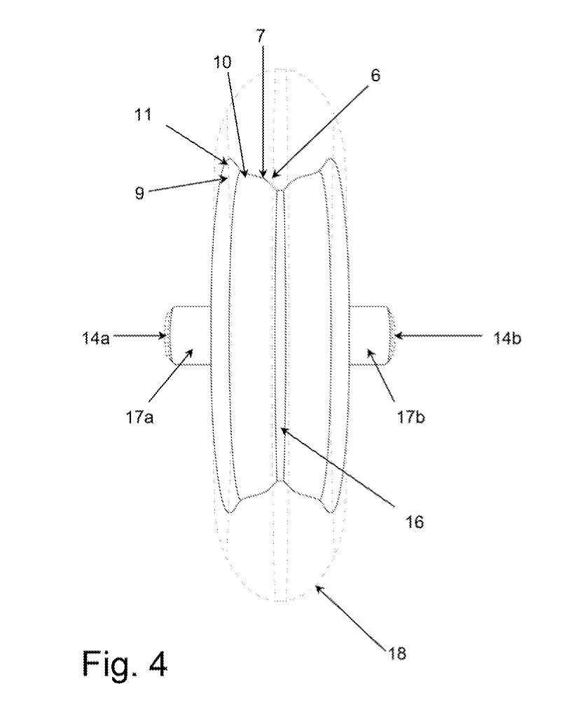

The wheelbarrow rim is described as if formed only by a single section as illustrated in FIG. 2, however, the rim of the present invention consists of two sections as illustrated in FIG. 2. FIG. 4 shows the joining of each section to form the rim as described in greater detail in the present specification. The knowledge of the present invention, specifically the central radial ribs might be used in different types of wheelbarrow rims that differ from the rim illustrated above.

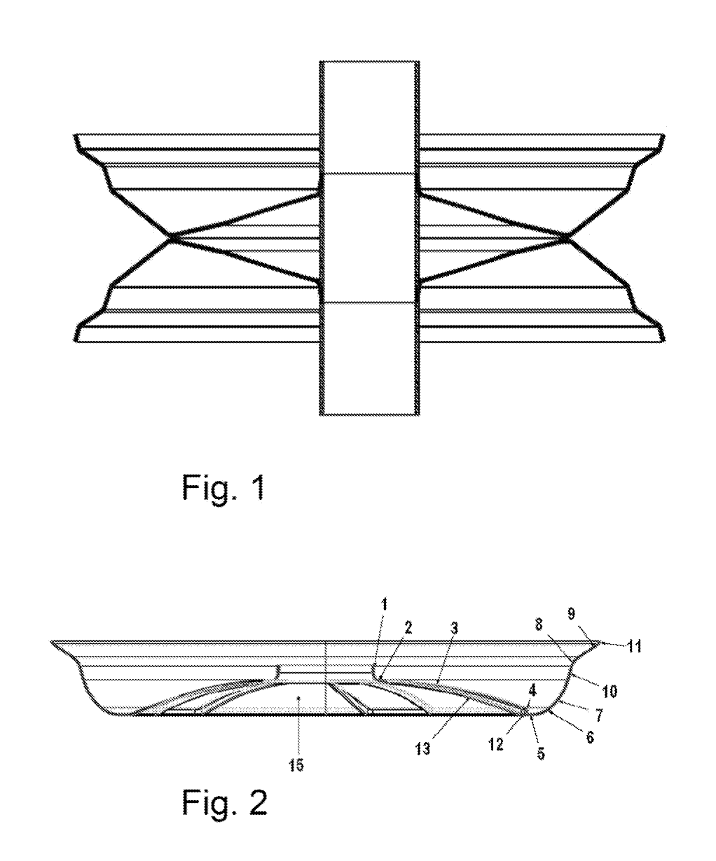

FIG. 1 shows a cross-section view of a rim of the state of the art. Specifically, the rim consists of two portions formed each by straight sections that form flat surfaces, and are made of a metal sheet gauge 18. It is a known fact in the art of wheelbarrow rims that the resistance of a mechanical element (rim) is directly related to the form or geometry of the element, independently of the material and forces being applied to the same. Based on this concept, the main characteristic that determines the resistance of a rim is either by the moment of inertia, defined as Ix, or by the section module, defined as Sx. Applying the moment of inertia of an arc as well as the Parallel Axis Theorem to a rim as shown in FIG. 1, the resulting moment of inertia (ΣI) is 257.632 cm⁴.

The following table corresponds to FIG. 1:

TABLE 1
Rim sections of FIG. 1.

| | | | | | | 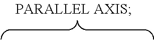 | |
|---|---|---|---|---|---|---|---|
| No | R (cm) (b) | R (cm) (h) | Area (cm2) | α | I (cm4) | d (cm) | I |
| 1 | 0.535 | 0.121 | 0.064735 | | 0.0000789821 | 1.965 | 0.250035382 |
| 2 | 0.320 | 0.200 | 0.04483309 | 82.3 | 0.000132986 | 2.225 | 0.2220848 |
| 3 | 17.121 | 17.000 | 0.45053795 | 12.5 | 12.42196288 | 0.725 | 12.65877689 |
| 4 | 0.121 | 1.499 | 0.181379 | | 0.033963233 | 6.445 | 7.568088669 |
| 5 | 0.950 | 0.829 | 0.08681955 | 46.2 | 0.034509993 | 7.4 | 4.78874863 |
| 6 | 14.871 | 14.750 | 0.28786387 | 9.2 | 5.981447137 | 0.568 | 6.074318929 |
| 7 | 0.640 | 0.635 | 0.00249885 | 44.9 | 0.000096201 | 9.445 | 0.223013975 |
| 8 | 0.391 | 0.121 | 0.047311 | | 0.000057723 | 10 | 4.731157723 |
| 9 | 0.760 | 0.640 | 0.05793228 | 39.5 | 0.016950922 | 10.8 | 6.774172061 |
| 10 | 0.875 | 0.121 | 0.105875 | | 0.000129176 | 10.763 | 12.26461882 |
| 11 | 0.397 | 0.276 | 0.03128004 | 44 | 0.001941026 | 10.919 | 3.731290535 |
| 12 | 0.331 | 0.121 | 0.040051 | | 0.000048866 | 11.308 | 5.12140484 |
| 13 | | | | | | | |
| 14 | | | | | | | |

Where:
A = Area;
R = Major radius
r = Minor radius
b = base
h = height
α = angle
d = distance
Ix = moment of inertia

To calculate the moment of inertia of an arc, the following formula is used:

$$\overline{I} = 0.1098 ( R 4 - r 4 ) - \frac{0.283 * R 2 * r 2 ( R - r )}{( R + r )} \qquad ( 1 )$$

The moment of inertia is obtained by Formula 1, and then by applying the parallel axis theorem in Equation 2:

I=Ī+Ad2 (2)

the moment of inertia I of Table 1 is obtained.

In Table 1 the ΣA is 5.6045 cm² while ΣI is 257.632 cm⁴.

FIG. 2 is a cross-section view of the first portion of the wheelbarrow rim according to the main embodiment of the present invention, which consists of different sections. Specifically a rim neck section (1), a neck fold section (2), a radial central rib section (3), a rib step section (4), base surface section (5), a curvature section “a” (6), a curvature section “b” (7), an outer curvature section (8), a flange section (9), a curvature-change section (10), a flange end section (11), a transfer section (12), and finally a rib lateral step (13) are shown.

Please note that although different parts of the rim section are mentioned, said rim consists of a single piece manufactured by the following steps: drawing, central pivot-punching and final cutting.

The rim formed by the sections as illustrated in FIG. 2 has a diameter of 222 mm, and a width of 65.6 mm. The sections as shown in FIG. 2 are welded together by 2 mm perimetric fillet weld (shown in FIG. 4), and have a section area of 7.4740 cm². For the sections (1 to 13) forming the rim portion, several measurements were taken, as shown in Table 2.

Please note that in the section where the base surface section (5) and the curvature section “a” (6) are formed, once the central radial rib section (3) ends, a section is formed which transitions from a curvature direction to another, which advantageously increases the moment of inertia of said portion.

TABLE 2
Rim section of FIG. 2.

| | | | | | — | 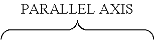 | |
|---|---|---|---|---|---|---|---|
| No. | R (cm) (b) | r (cm) (h) | Area (cm2) | α | I (cm4) | d (cm) | I cm4 |
| 1 | 0.329 | 0.106 | 0.034874 | | 0.0000326537 | 1.958 | 0.1337313394 |
| 2 | 0.500 | 0.394 | 0.071974206 | 87 | 0.001024348 | 2.045 | 0.3020222752 |
| 3 | 16.000 | 15.894 | 0.622746871 | 21.1 | 6.000718601 | 2.175 | 8.9467005 |
| 4 | 0.150 | 0.050 | 0.01182042 | 67.7 | 0.000017655 | 8.3 | 0.8143263887 |
| 5 | 0.106 | 0.346 | 0.036676 | | 0.000365892 | 8.357 | 2.5617975235 |
| 6 | 1.000 | 0.894 | 0.074137929 | 42.3 | 0.006345824 | 8.58 | 5.4641132719 |
| 7 | 2.656 | 2.550 | 0.159460186 | 33.1 | 0.102446994 | 7.466 | 8.9909421018 |
| 8 | 0.760 | 0.640 | 0.58812264 | 40.1 | 0.002778353 | 10.806 | 6.8702650128 |
| 9 | 0.984 | 0.106 | 0.104304 | | 0.000097663 | 10.798 | 12.16161071 |
| 10 | 0.603 | 0.106 | 0.063918 | | 0.000059849 | 10.06 | 6.4687915534 |
| 11 | 0.306 | 0.200 | 0.018074152 | 38.6 | 0.000739397 | 11.048 | 2.2068397371 |
| 12 | 0.120 | 0.106 | 0.01272 | | 0.000011910 | 8.204 | 0.8561393457 |
| 13 | 15.106 | 15.000 | 0.598979041 | 21.5 | 12.856800357 | 1.579 | 14.35019946 |
| 14 | | | | | | | |

Where:
A = Area;
R = Major radius
r = Minor radius
b = base
h = height
α = angle
d = distance
Ix = moment of inertia

To calculate the moment of inertia of an arc, the following formula is used:

$$I = 0.1098 ( R 4 - r 4 ) - \frac{0.283 * R 2 * r 2 ( R - r )}{( R + r )} \qquad ( 3 )$$

The moment of inertia is obtained by Formula 3, and then by applying the parallel axis theorem of Equation 4:

I=Ī+Ad2 (4)

This results in the moment of inertia I of Table 2.

In Table 2, ΣA is 7.4740 cm², while ΣI is 280.510 cm⁴.

The following is a comparison between FIG. 1—Table 1, and FIG. 2—Table 2:

TABLE 3
Comparison between the rim of the present invention
and the rim of the state of the art.

| CHARAC- | RIM OF THE | | RIM OF THE STATE | |
|---|---|---|---|---|
| TERISTIC | PRESENT INVENTION | | OF THE ART | |
| MATERIAL | SAE 1010 | | SAE 1010 | |
| GAUGE | 19 (1.06 mm; 0.01418″) | | 18 (1.21 mm; 0.0478″) | |
| OUTER DIAMETER | 222 | mm | 226 | mm |
| WIDTH OF RIM | 65.6 | mm | 73.8 | mm |
| TYPE OF WELDING | 2 mm Perimetral | | 2 mm Perimetral | |
| | fillet weld | | fillet weld | |
| SECTION AREA | 7.4740 | cm² | 5.6045 | cm² |
| MOMENT OF | 280.51 | cm² | 257.632 | cm⁴ |
| INERTIA Ixx | | | | |

### Furthermore:

$$σ = \frac{Mmax}{S} = \frac{M c}{Ix} \qquad ( 5 )$$

### And

$$Fmax = \frac{σ max * Ix}{d c} \qquad ( 6 )$$

Equation (5) corresponds to the bending resistance of a component, and Equation (6) the maximum applied force to an element given the moment of inertia, and the distance of the general center of gravity of the geometry to the specific center of gravity of each geometric element that forms the rim. Where, for Equations 5 and 6:

Mmax=Maximum momentum

σ=Bending resistance

Ix=Moment of Inertia

c=Distance of the general centroid to the specific center of gravity of each geometry that forms the rim.

d=Distahce of the maximum force applied to the general center of gravity of the geometry.

Since in both equations the loads and bending resistance of the material are constant, we assumed that by performing variations in the geometry of the piece, significant improvements in the resistance of the component can be achieved. Hence, we propose a new geometry of the rim, and evaluate the resistance criteria given by Equations 5 and 6, where the resistance is directly proportional to the increase of the general moment of inertia of the shape.

The distortion criteria were determined through field experiments, where the structural stability of the component was verified under cyclical constant loads or fluctuating intensity loads.

It is inferred that the greater the moment of inertia, the greater the load capacity. It is obvious that the ribs proposed in the present invention increase the load capacity. Although the proposed rim is made of a metal sheet gauge 19 (1.02 mm), compared to the rim of the state of the art made of a metal sheet gauge 18 (1.21 mm), it has a greater moment of inertia, and therefore, a greater load capacity. This is achieved through the proposed ribs, and the geometry of the rim.

FIG. 2 shows the portion of the rim formed by the rim neck section (1), where its rotation center is located, which joins with the neck fold section (2), thereby forming the front side (15). Said front side (15) is substantially circular, and has a curvature that extends up to the transference section (12) in the portions that do not have ribs. The central radial rib section (3) is formed in said front side (15), and protrudes from it by means of a rib step (4) until reaching the base surface section (5) through the rib lateral step (13) making the radial central rib section (3) to protrude. Furthermore, there is a transference section (12) that reaches the base surface (5), and then the curvature section “a” (6) and the curvature section “b” (7), until the curvature-change section (10) produces the outer curvature section (8), and reaches the flange section (9) and its end section (11). These curvatures, which are used to calculate the moment of inertia of an arc in Table 2 and Formulae 3 and 4, show the innovation of the geometric shape of the wheelcart rim of the present invention. As shown in FIG. 2, there is a series of curvatures (not flat sections like in the state of the art). For example, the central ribs (3) form a radius that changes direction to form an arc consisting of a base surface section (5), the curvature section “a” (6), the curvature section “b” (7), and the curvature-change section (8) followed by an outer curvature section (8) that ends in a flange section (9), and its respective end (11). The shape of these curvatures produces an innovative geometric shape compared with the existing state of the art. Please note that FIG. 2 neither shows the rim axis nor the respective bearings, or the second section of the rim, however, these will be described below.

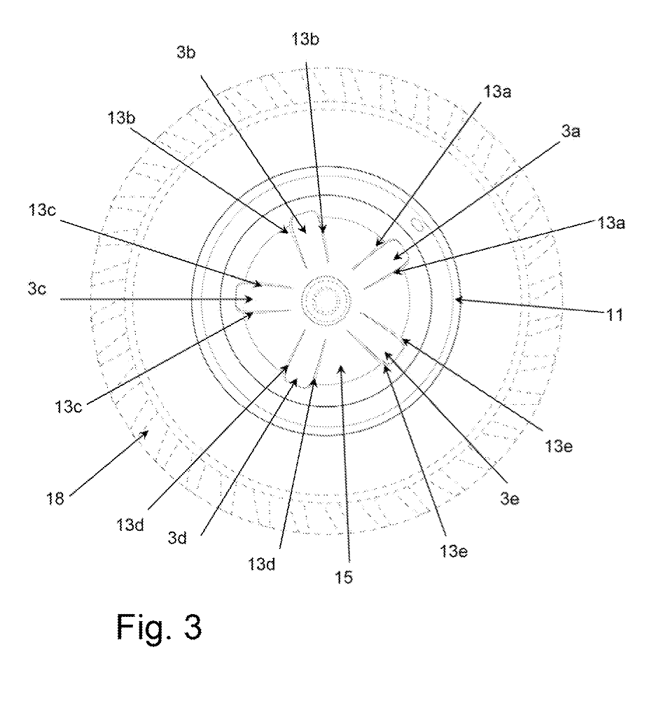

FIG. 3 shows a front view of the wheelbarrow rim of the present invention, being evident the configuration of the five radial central ribs (3a, 3b, 3c, 3d and 3e), which are spaced apart equidistantly from each other. The five radial central ribs (3a, 3b, 3c, 3d and 3e) have a semi-rectangular shape and rounded edges, where the portion closer to the rim neck tries to even up the front side (15), and forms the step until reaching the opposite end, this constitutes an advantage that makes easier the manufacturing process and avoids the waste of materials in mass production. Also shown is the rib lateral step (13a, 13b, 13c, 13d and 13e) at each side of the five central ribs (3a, 3b, 3c, 3d, and 3e). Furthermore, the radial central ribs (3a, 3b, 3c, 3d, and 3e) are formed in the front side (15) of the wheelbarrow, and in the center of said front side there is a series of elements that end at the bearings (14), which can change sizes as required by the wheelbarrow.

FIG. 4 is a lateral view of the two portions of the wheelbarrow rim welded together by a perimetric fillet weld (16). FIG. 4 also shows that the portions of the rim are completely symmetric and both sides are formed by the same elements shown in FIG. 2. FIG. 4 shows the curvature section “a” (6), the curvature section “b” (7), reaching the curvature-change section (10) to form the outer curvature (8), and reach the flange (9) and its end (11), hence forming innovative radiuses compared to the current state of the art. Additionally, the rim axis (17a and 17b) are shown with the bearings (14a and 14b), and the tire (18), which may be changed as required (i.e. tube tires, tubeless tires, narrow section tires, etc.)

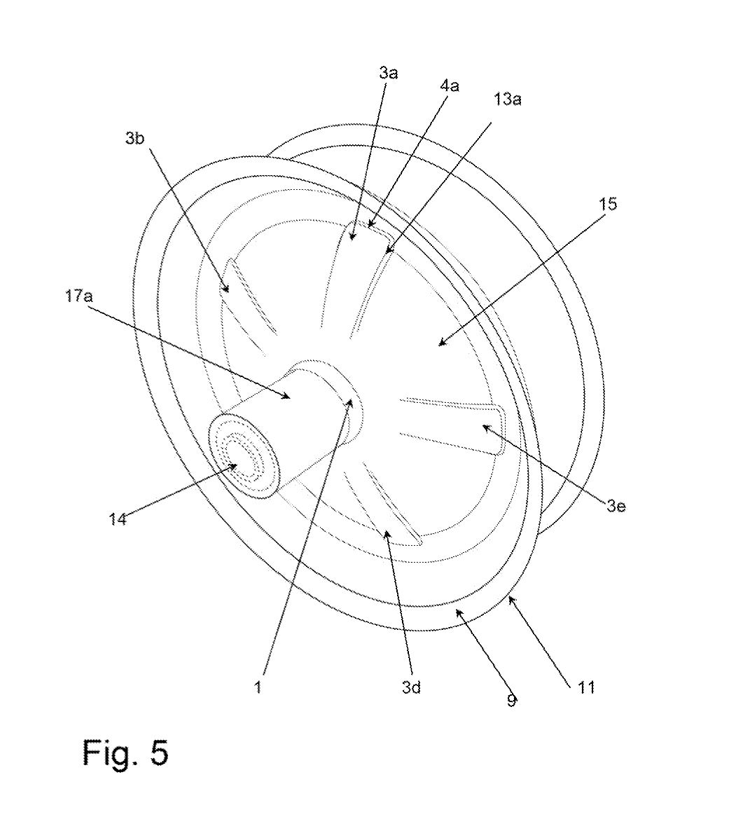

FIG. 5 is a perspective view of the wheelbarrow rim of the present invention showing the radial central ribs (3a, 3b, 3d and 3e, other rib is not shown). FIG. 5 also shows that the radial central rib (3a) is formed by a rib lateral step (13a), and a rib step (4a). Although not clearly shown in FIG. 5, there is a rib lateral step on the opposite side of the rib step (13a), hence all the radial central ribs protrude from the front side (15). Likewise, the rim neck (1), the rim axis (17a), and the bearings (14a) and flange (9) with its end (11) are shown.

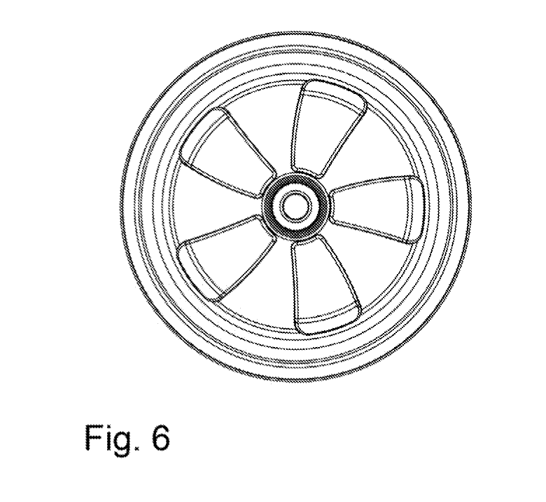

FIG. 6 refers to a front view of a wheelbarrow rim which can be made by the with the teachings of the present invention, the wheelbarrow rim showed in FIG. 6 is conformed by five radial central ribs having the same technical features showed in this specification.

Please note that each of the radial central ribs described herein has the same dimensions, as well as rib lateral steps and rib steps, therefore, the description is not limited to explain a single central rib, but applies to all of them.

The present description details a wheelbarrow rim formed by fitting together two portions made of a metal sheet gauge 19, a that also saves production material.

The radial central ribs described in the preferred embodiment of the invention have a semi-rectangular shape with rounded edges, where the portion closer to the rim neck tries to even up the front side, and forms the step until reaching the opposite side, as shown in the figure. However, other radial central rib shapes (i.e. triangular, square, semi-circular) may be designed when taking advantage of the teachings of the present invention, and with similar moments of inertia would fall within the scope of protection sought hereby.

The geometric configuration of the present invention is the preferred one, that is, the curvatures as shown in the figures of the preferred embodiment. However, rims with curvatures different from the teachings of the present invention may be developed, and would fall within the scope of protection sought.

For the present invention, a metal sheet gauge 19, SAE 1010 is preferred for manufacturing the rim, as well as the above described ribs and geometry. However, with the teachings of the present invention different materials and gauges may be used in manufacturing the rims.

1. A wheelbarrow rim formed by two rim portions welded together by a perimetric fillet weld, characterized by each rim portions comprising:
five central radial ribs in the front side of said portions, and a series of sections that form the rim.

2. The wheelbarrow rim of claim 1 characterized by the following sections:
a rim neck section (1), a neck fold section (2), a radial central rib section (3), a rib step section (4), base surface section (5), a curvature section “a” (6), a curvature section “b” (7), an outer curvature section (8), a flange section (9), a curvature-change section (10), a flange end section (11), a transfer section (12), and finally a rib lateral step (13).

3. The wheelbarrow rim of claim 1 further characterized by:
rim axis (17a and 17b) carrying bearings (14a and 14b) and a tire (18).

4. The wheelbarrow rim of claim 2 characterized by:
the five radial central ribs are equidistantly spaced apart from each other.

5. The wheelbarrow rim of claim 2 characterized by:
the five radial central ribs (3a, 3b, 3c, 3d and 3e) have a semi-rectangular shape with rounded edges.

6. The wheelbarrow rim of claim 2 characterized by:
the portion of the radial central ribs being closer to the rim neck tries to even up the front side, and forms the step until reaching the opposite end.

7. The wheelbarrow rim of claim 2 characterized by:
the radial central ribs having on each side, lateral steps and a rib step that are formed on the front side of the wheelbarrow rim.

8. The wheelbarrow rim of claim 1 characterized by:
being manufactured of a metal sheet gauge 19.
